(19) United States
(12) Patent Application Publication
(10) Pub. No.: US 2003/0100341 A1
(43) Pub. Date: May 29, 2003

(54) Support structure for a mobile communications device

(76) Inventor: John Etheridge, Bitterne (GB)

Correspondence Address: BRIAN T. RIVERS, NOKIA INCORPORATED, 6000 CONNECTION DRIVE, MD 1-4-755, IRVING, TX, 75039, US

(21) Appl. No.: 09/994,562

(22) Filed: Nov. 27, 2001

(51) Int. Cl. H04M 1/00

(52) U.S. Cl. 455/557; 455/345

(57) ABSTRACT

The invention provides a support structure (1) for a mobile communications device (100) comprising a dampening mechanism (400) to dampen the insertion of the mobile communications device into the support structure (1) wherein the dampening mechanism comprises a geared arrangement to control the speed of insertion of the mobile communications device (100) into the support structure. Such a support structure (1) provides a controlled speed on insertion of the mobile communications device (100) and this controls the impact of the mobile communications device (100) with the support structure (1). Potential damage to the support structure (1)/mobile communications device (100) is reduced.

The invention relates to a support structure for a mobile communications device. The basic function of the support structure is to hold the mobile communications device when the mobile communications device is not on the move. Conveniently, such support structures often have the facility to recharge the mobile communications device, and are often configured to provide support to the mobile communications device in a vehicle or on a desktop. So-called mobile telephone cradles are within the scope of the present invention.

A mobile communications device within the context of this invention is any portable electronic device which allows the user of the device to interface directly with another electronic device or indirectly with another user via another electronic device. Included are mobile telephones, and so-called Personal Digital Assistants (PDAs).

The present invention provides a support structure for a mobile communications device comprising a dampening mechanism to dampen the insertion of the mobile communications device into the support structure wherein the dampening mechanism comprises a geared arrangement to control the speed of insertion of the mobile communications device into the support structure.

Engagement of the mobile communications device with the geared arrangement upon insertion of the mobile communications device into the support structure provides controlled deceleration of the mobile communications device, and accordingly controls the speed of insertion of the mobile communications device into the support structure. By reducing the speed of insertion, the speed of impact of the mobile communications device with the support structure is reduced, and accordingly potential damage to the mobile communications device/support structure reduced.

Preferably, the support structure comprises a data/power connection means and the support structure is arranged such that the geared arrangement controls the speed of mating/withdrawal of the data/power connections means with a respective data/power connection means of a mobile communications device. Potential damage to the mobile communications device/support structure connection means is accordingly reduced.

The support structure may also be arranged such that the geared arrangement guides the mating/withdrawal of the respective connection means. Such an arrangement reduces movement which is likely to damage the respective connection means during mating/withdrawal.

The support structure connection means may be a male or female connection arrangement. It will be appreciated that the power connection means allows power to be supplied to the mobile communications device so, for example, it may be re-charged while it is being held within the support structure. Similarly, it will be appreciated that the data connection means allows the transmission of data between the mobile communications device and another electronic communications device using a wired interface.

In one preferred embodiment, the support structure comprises a platform arranged to engage with mobile communications device and move into/out of the support structure, and wherein the geared arrangement is arranged to control the in/out movement of the platform.

Engagement with the platform, and thus the geared arrangement, will decelerate the mobile communications device and will accordingly reduce the impact with the support structure. The geared arrangement would also act to guide the insertion/withdrawal of the platform into/from the support structure. The insertion of the platform into the support structure may be whole or partial.

In a preferred embodiment, the platform is arranged to protect the data/power connection means. In this case, the support structure comprises data/power connection means located proximal to the platform to allow controlled mating between respective connection means upon insertion of the platform into the support structure. The platform will not only act to decelerate the mating process, but also act as a guide to allow correct mating. Similarly, controlled disconnection will also be provided. The mating/disconnection of the respective connection means may occur following partial or complete insertion of the platform into the support structure.

Preferably, the connection means is contained within the support structure housing to allow access by the connection means of a mobile communications device when the mobile communications device is appropriately positioned on the platform, and the platform comprises an orifice into the housing to allow mating of the connection means of the mobile communications device with the support structure connection means.

Preferably, the support structure extends in the vertical plane to support the mobile communications device in an upright configuration. Particularly, but not exclusively in this case, it would be advantageous for the platform to be arranged to support the base of a mobile communications device. Such an arrangement will advantageously control the vertical insertion speed of the mobile communications device, which is subject to the pull of gravity.

In a preferred embodiment, the geared arrangement comprises a rack arranged to engage with a gear wheel to allow controlled translational movement of the dampening mechanism. This has the advantage that it is a very simple arrangement.

In one specific case, the platform comprises the rack arranged to engage with a gear wheel attached to a fixed position on the support structure. The fixed position of the gear wheel allows rotation of the gear wheel but prevents translational movement.

Preferably, movement of the platform is arranged to be guided by guide pins. Preferably, the support structure comprises one or more channels arranged to house a guide pin. The channels may not only just house a guide pin, but may also house anything else encircling the guide pin.

Preferably, the platform is arranged to be biased between the in and out positions by biasing means. Thus, controlled insertion and withdrawal of the platform is provided.

The biasing means may be one or more springs, or may be one or more flexible lugs arranged to flex upon compression to store up compressive energy which is subsequently released by deflexion. Preferably, one or more of the guide pins are encircled by one or more springs.

Preferably, the support structure comprises one or more end stop arrangements to delimit the movement of the platform. This may be to delimit insertion and/or withdrawal of the platform in/out of the support structure.

The support structure may be limited to being a mobile communications device support structure. The aforementioned embodiments singly or in any combination are all within the scope of the present invention.

Specific embodiments of the present invention will now be described by way of example only with reference to the following Figures in which:

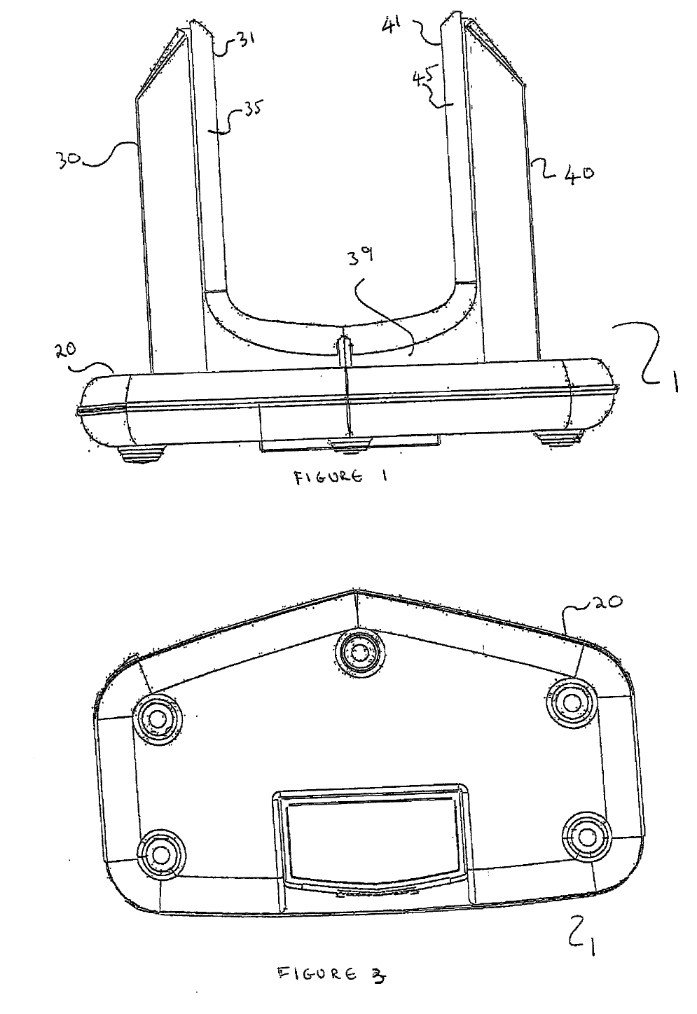

FIG. 1 is a front elevation of a support structure according to one embodiment of the present invention;

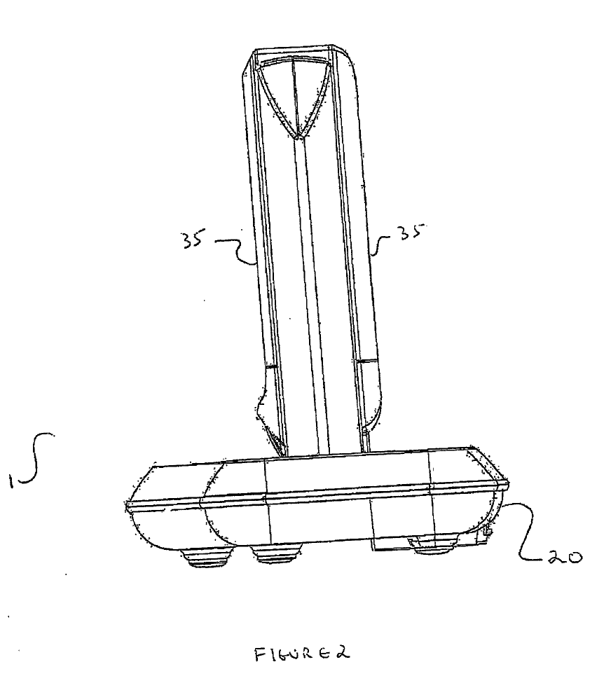

FIG. 2 is a side elevation of the support structure of FIG. 1;

FIG. 3 is a view of the underneath of the support structure of FIG. 1;

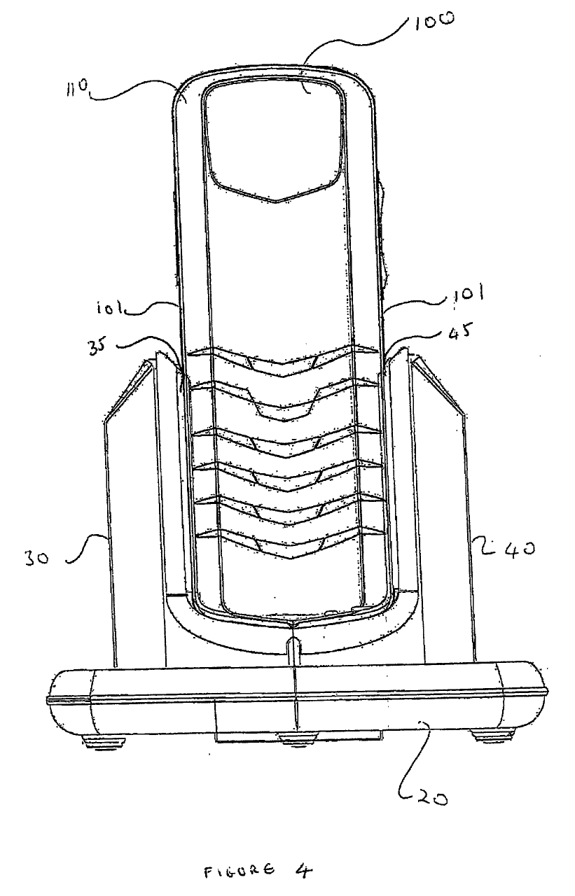

FIG. 4 is the front elevation of FIG. 1 with the support structure holding a mobile communications device;

FIG. 5 is the side elevation of FIG. 2 with the support structure holding a mobile communications device;

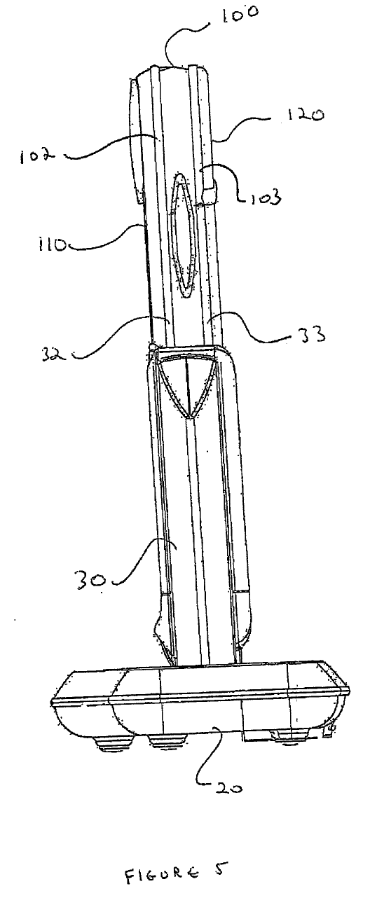

FIG. 6 is plan elevation of the support structure of FIG. 1;

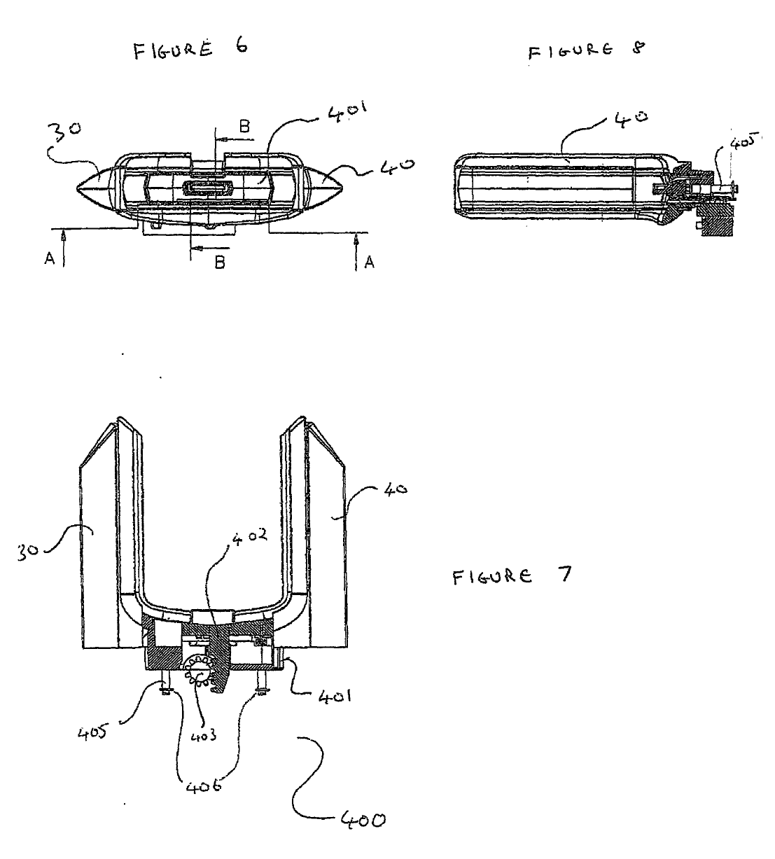

FIG. 7 is a front cross section along lines A-A of FIG. 6;

FIG. 8 is a lateral cross section along lines B-B of FIG. 6;

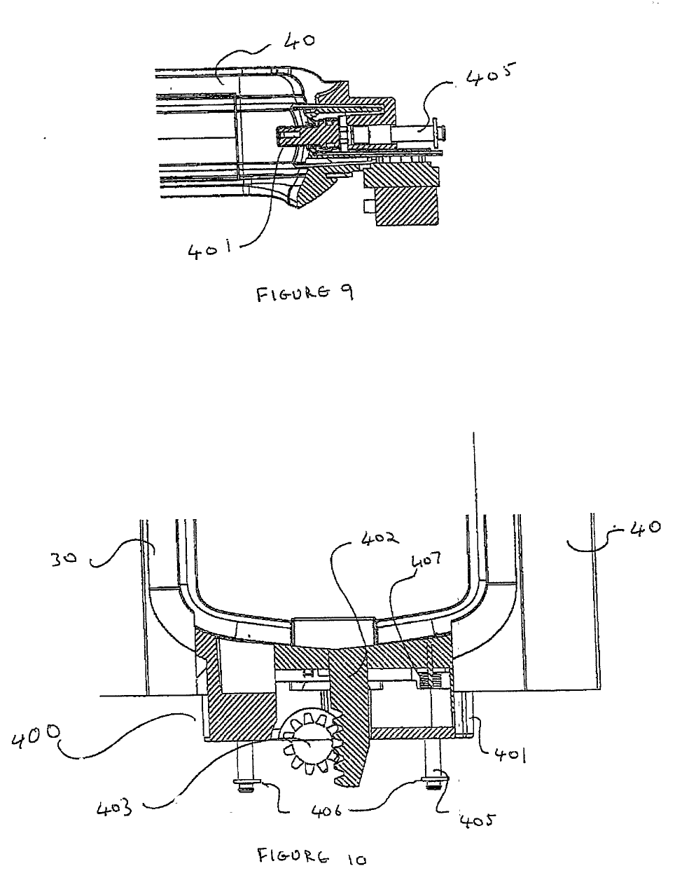

FIG. 9 is an exploded cross sectional view of the base portion of the support structure shown in FIG. 8;

FIG. 10 is an exploded cross sectional view of the base portion of the support structure shown in FIG. 7.

In the present example, the mobile communications device is a mobile telephone 100 and the support structure is a mobile telephone cradle 1. Mobile telephones 100 are well known in the art and only features of the mobile telephone 100 which give understanding to the function and features of the cradle 1 will be described.

The cradle 1 comprises a base section 20 (FIGS. 1 and 2). The base section 20 provides stability to the cradle 1 and is used to place the cradle 1 on the surface of a desk. The under-carriage of the base section 20 has a number of support pads 21 arranged around the perimeter to allow the stable placement of the cradle 1 on a desk (FIG. 3).

Two upright opposing lateral support members 30, 40 extend from an upper surface of the base section 20 (FIGS. 1 and 2). They are fixed to the base section 20 and cannot move with respect to the base section 20 i.e. they are static. The lateral support members 30, 40 are spaced apart on the base section 20 by a suitable distance for a mobile telephone 100 to be placed there-between (FIG. 4). The support members 30, 40 extend form the base section 20 to a length such that when the mobile phone is supported there-between, only approximately 50% of the sides 101 of the mobile telephone 100 are covered by the support members 30, 40 and the rest of the mobile telephone projects above the cradle 1 (FIG. 5). Accordingly, it can be said that the cradle 1 extends in the vertical plane to support the mobile telephone 100 in an upright configuration.

The leading edges 35, 45 of the lateral support members 30, 40 are turned inwardly to provide lateral support and inhibit front/back movement of the mobile phone 100 (FIGS. 1, 2 and 4).

Only a small portion 39 of the lateral support members 30, 40 towards the base section 20 are joined. Otherwise, the lateral support members 30, 40 extend freely away from the base section 20 without any interconnection. This leaves both the front and rear faces 110, 120 of the mobile telephone 100 free from obstruction (FIG. 4).

The lateral support members 30, 40 have facing surfaces 31, 41 which are used to engage with the sides 101 of mobile telephone 100. The facing surfaces 31 of the lateral support members 30, 40 have a concave profile (FIG. 6) to engage with the convex profile (not shown) of the mobile telephone 100.

The lateral support members 30, 40 each have two adjacent grooves 32, 33 and 42, 43 (not shown) which engage with corresponding adjacent rails 102, 103 on the sides 101 of the mobile telephone 100 (FIG. 5). The engagement of the rails 102, 103 in respective grooves 32, 33, 42, 43 holds the mobile phone 100 firmly in place in the cradle 1. The base section 20 may also comprise power charging connection means 300 (not shown) and the grooves 32, 33, 42, 43 would be arranged such that cooperation of the rails 102, 103 with the respective grooves 32, 33, 42, 43 would, in this case, also guide the mobile telephone 100 to correctly engage with the power charging connection means 300.

Ordinarily, the lateral support members 30, 40 would be spaced apart to provide a snug fit for the mobile telephone 100 held between the lateral support members 30, 40. To avoid wear and tear, the engaging surfaces 31, 41 of the lateral support members 30, 40 are either made from or have a layer of a wear resistant material, such as Molybdenum loaded nylon. In the case where the rails 102, 103 are made from stainless steel, such a material provides excellent wear resistant properties.

The base section 20 comprises a dampening mechanism 400 which is positioned over the connection means 300 (not shown). The purpose of the dampening mechanism 400 is to control and guide the mating/disconnection of the connection means 300 with the corresponding connection means (not shown) located on the base of the mobile phone 100.

To this end, the dampening mechanism comprises a platform 401 arranged to receive the base of a mobile phone 100. The platform 401 is arranged to move in and out of an aperture in the base section 20 depending upon whether or not a mobile phone 100 is engaged with the platform 401. When a mobile phone 100 is placed on the platform 401, the platform 401 retreats into the aperture and allows mating of the mobile phone connection means with the support structure connection means 300. Access to the connection means 300 for the corresponding connection means in the mobile phone 100 is through an orifice 410 in the platform 401 (FIG. 6).

The controlled retreat of the platform 401 into the aperture is provided by a rack 402 which engages with a gear wheel 403. The rack 402 is fixed to the platform 401 and extends downwardly. The gear wheel 403 is in a fixed position within the cradle 1 but is mounted so that it is still able to rotate. The rack teeth are located laterally and the rack 402 and gear wheel 403 are mutually arranged such that their teeth engage laterally.

In operation, the rack 402 is pushed downwardly upon the placement of a mobile telephone 100 on the platform 401. However, travel of the rack 402 downwardly, and therefore downward travel of the platform 401 and mobile phone 100 also, is resisted/controlled by the engagement of the rack teeth with the gear wheel. Similarly, such resistance applies during upward movement of the platform 401.

The dampening mechanism 400 comprises guide pins 405 to provide stability during movement of the platform 401. Each of the guide pins 405 are attached to the base of the platform 401 and extend vertically therefrom. In the case shown, two parallel guide pins 405 spaced laterally apart are provided. These pins 405 travel within corresponding parallel vertical channels provided within the cradle 1. Accordingly, the channels restrict the movement of the pins 405 contained therein and therefore restrict the movement of the platform 401.

The guide pins 405 also comprise end stops 406 at either end which delimit vertical movement of the platform by abutment with the open faces of the cradle channels. The end stops 406 are dimensioned so that they are too big to enter the cradle channels through the respective open faces.

Springs 407 are provided to encircle the pins 405. The springs act to decelerate the downward movement of the platform 401. They also act to bias the platform 401 back upon removal of the mobile phone 100 from the platform 401.

1. A support structure for a mobile communications device comprising a dampening mechanism to dampen the insertion of the mobile communications device into the support structure wherein the dampening mechanism comprises a geared arrangement to control the speed of insertion of the mobile communications device into the support structure.

2. A support structure as claimed in claim 1, wherein the support structure comprises a data/power connection means and the support structure is arranged such that the geared arrangement controls the speed of mating/withdrawal of the data/power connections means with a respective data/power connection means of a mobile communications device.

3. A support structure as claimed in claim 1, wherein the support structure extends in the vertical plane to support the mobile communications device in an upright configuration.

4. A support structure as claimed in claim 1, wherein the support structure comprises a data/power connection means and wherein the support structure is arranged such that the geared arrangement guides the mating/withdrawal of the respective connection means.

5. A support structure as claimed in claim 1, wherein the support structure comprises a platform arranged to engage with mobile communications device and move into/out of the support structure, and wherein the geared arrangement is arranged to control the in/out movement of the platform.

6. A support structure as claimed in claim 5, wherein the support structure is arranged to allow the insertion of the whole of the platform into the support structure.

7. A support structure as claimed in claim 5, wherein the platform is arranged to protect the data/power connection means.

8. A support structure as claimed in claim 7, wherein the support structure comprises data/power connection means located proximal to the platform to allow controlled mating between respective connection means upon insertion of the platform into the support structure.

9. A support structure as claimed in claim 8, wherein the connection means is contained within the support structure housing to allow access by the connection means of a mobile communications device when the mobile communications device is appropriately positioned on the platform, and the platform comprises an orifice into the housing to allow mating of the connection means of the mobile communications device with the support structure connection means.

10. A support structure as claimed in claim 9, wherein the platform is arranged to support the base of a mobile communications device.

11. A support structure for a mobile communications device comprising a dampening mechanism to dampen the insertion of the mobile communications device into the support structure wherein the dampening mechanism comprises a geared arrangement to control the speed of insertion of the mobile communications device into the support structure, and wherein the geared arrangement comprises a rack arranged to engage with a gear wheel to allow controlled translational movement of the dampening mechanism.

12. A support structure as claimed in claim 11, wherein the platform comprises the rack arranged to engage with a gear wheel attached to a fixed position on the support structure.

13. A support structure as claimed in claim 11, wherein movement of the platform is arranged to be guided by guide pins.

14. A support structure as claimed in claim 13, wherein the support structure comprises one or more channels arranged to house a guide pin.

15. A support structure as claimed claim 14, wherein the platform is arranged to be biased between the in and out positions by biasing means.

16. A support structure as claimed in claim 13, wherein one or more of the guide pins are encircled by one or more springs.

17. A support structure as claimed in claim 16, wherein the biasing means comprises one or more springs.

18. A support structure as claimed in claim 16, wherein the biasing means comprises one or more flexible lugs arranged to flex upon compression to store up compressive energy which is subsequently released by deflexion.
